(19) United States
(12) Patent Application Publication
(10) Pub. No.: US 2015/0221231 A1
(43) Pub. Date: Aug. 6, 2015

(54) MUSICAL NOTATION SYSTEMS AND METHODS

(71) Applicant: LEARNBALANCE CO., LTD., Bangkok (TH)

(72) Inventor: Tanate Ua-Aphithorn, Bangkok (TH)

(21) Appl. No.: 14/421,810

(22) PCT Filed: Aug. 15, 2013
(86) PCT No.: PCT/US13/55222

§ 371 Date: Feb. 13, 2015

Related U.S. Application Data
(60) Provisional application No. 61/742,630, filed on Aug. 15, 2012.

(51) Int. Cl. G09B 15/02

(52) U.S. Cl. CPC G09B 15/02

(57) ABSTRACT

A musical notation system employing a dozenal, or base-12 approach to representing musical notes and compositions in a dynamic, clock-face format is described. A static, lined notation system derived from the base-12 radial notation system is also described.

### REFERENCE TO PRIORITY PROVISIONAL PATENT APPLICATION

This application claims priority from U.S. Provisional Patent Application No. 61/742,630 filed Aug. 15, 2012. The disclosures of the previously filed provisional patent application, is incorporated by reference herein in its entirety.

### TECHNICAL FIELD

The present invention relates to methods and systems for musical notation.

### BACKGROUND

The commonly used music notation system uses a five-line staff, most commonly both a treble and a bass staff. The lines are spaced equi-distant from one another and note pitch is shown by placement of notes with respect to each line of the staff, with notes being located both on and between the lines. Notes representing a pitch outside the five line staff are represented using ledger lines, and some notes are indicated using flat and sharp indications.

A staff of written music generally begins with a clef. The treble or G clef identifies the second line up on the five line staff as the note G above middle C. The bass or F clef shows the position of the note F below middle C. Following the clef, the key signature on a staff indicates the key of the piece by specifying that certain notes are flat or sharp throughout the piece, unless otherwise indicated. Note duration is indicated by different note values and additional symbols such as dots and ties. The musical notation is read from left to right, and measures (bars) divide the composition into groups of beats. The time signature specifies those groupings. Directions to the player regarding tempo, dynamics and expression appear above or below the staff(s).

Learning this conventional musical notation system is difficult and time consuming. Many years of training and substantial knowledge of music theory are required to play complex musical compositions. Many attempts to develop simplified musical notation systems that are more accessible to students, and particularly young students, have been made. Some recent examples of alternative musical notation systems are shown and described in U.S. Pat. Nos. 8,039,722, 7,439,438, 6,288,316, 6,124,540, 7,253,349 and U.S. Patent Publication 2008/0072738. Alternative musical notation systems have also been developed for creating and performing a musical score using electronic and computer-implemented techniques and tools.

Despite many and varied efforts to simplify the traditional musical notation system, there is, to applicant's knowledge, no simplified musical notation system in wide usage. Applicant has therefore developed the new musical notation systems described and shown herein in an effort to provide musical notation systems that are easy to learn, easy to use, and amenable to representing music of all types and for all instruments.

### BRIEF DESCRIPTION OF THE DRAWINGS

FIGS. 1A, 1B and 1C illustrate the introduction of “My heart will go on” in the traditional musical notation in the key of E (FIG. 1A), in a new dynamic dozenal-based musical notation described herein in the key of E (FIG. 1B), and in the new musical notation described herein in the key of C (FIG. 1C). FIG. 1D illustrates how different colors are used to identify different octaves.

FIGS. 2A, 2B and 2C illustrate an adaptation of the radial dozenal-based musical notation system shown in FIGS. 1A-1D in a static, lined notation system. FIG. 2A shows an adaptation of the sequence of keys from the radial notation to a vertical axis notation, with reference to the diatonic and pentatonic scales. FIG. 2B further illustrates the adaptation of the radial dozenal notation to the vertical axis notation and shows the adaptation to a lined notation system corresponding to a dozenal notation. FIG. 2C illustrates the notes labeled on a lined notation system as disclosed herein (above) and an illustration of the introduction to “My heart will go on” in the lined notation corresponding to the dozenal-based system.

FIGS. 3A, 3B and 3C illustrate representations of chords in the radial dozenal notation (FIG. 3A), a corresponding lined notation (FIG. 3B) and the standard lined notation (FIG. 3C).

FIG. 4 illustrates chords and melody notes shown simultaneously using the base-12 line notation.

FIG. 5 illustrates melody notes shown in combination with chords in the base-12 radial, or “clock face” notation.

FIG. 6 shows the introduction of “My Heart Will Go On” expressed in a hybrid base-12 lined notation system in the key of E.

FIG. 7 illustrates yet another exemplary radial dozenal notation in which multiple radial elements may be combined to illustrate music played by different hands, or to illustrate both melody notes and chords.

### DETAILED DESCRIPTION

In one aspect, a musical notation system of the present invention utilizes a dynamic dozenal or base-12 system, graphically presented in a radial or clock-face format, for representing musical notes and musical compositions. In this dynamic musical notation system, various aspects and embodiments of which are illustrated in the accompanying figures, each of 12 equally spaced radial locations (such as those marking hours on the conventional clock face) represents one of the 12 pitches of the scale. Each of the 12 note pitches is thus represented as a radius of the clock face extending from the center to the perimeter at a location corresponding to an hour on the base-12 clock, with successive musical notes and pitches located in successive radial locations. Musical notes are expressed as colored markings located at radial locations corresponding to the individual notes. In some embodiments of the radial, clock-face base-12 notation system, the note located at a designated location, such as at the upper central 0 or 12 position, designates the musical scale key of the composition and the other notes (or keys) are arranged, sequentially, in a predetermined orientation, such as a clockwise orientation, with respect to the musical scale key.

The base-12 radial (clock face) format musical notation system is dynamic and is typically presented using an interactive, computer- and/or microprocessor-implemented system. Colored note indicators move dynamically from one area of the radial representation, or clock face, to another area as the music progresses, such as from outer perimeter regions of the clock face toward the center, or from the center or an inner location outwardly. In one embodiment, the notes and chords that are in the central location at any point in time are the notes being played, while in another embodiment, the notes and chords that are in a peripheral location at any point in time are the notes being played. Thus, musical compositions are “read” as note indicators move, dynamically, from one area of the clock face (e.g., the center) to another area (e.g. a peripheral area), rather than from left to right along a staff, as is done in the conventional musical notation system.

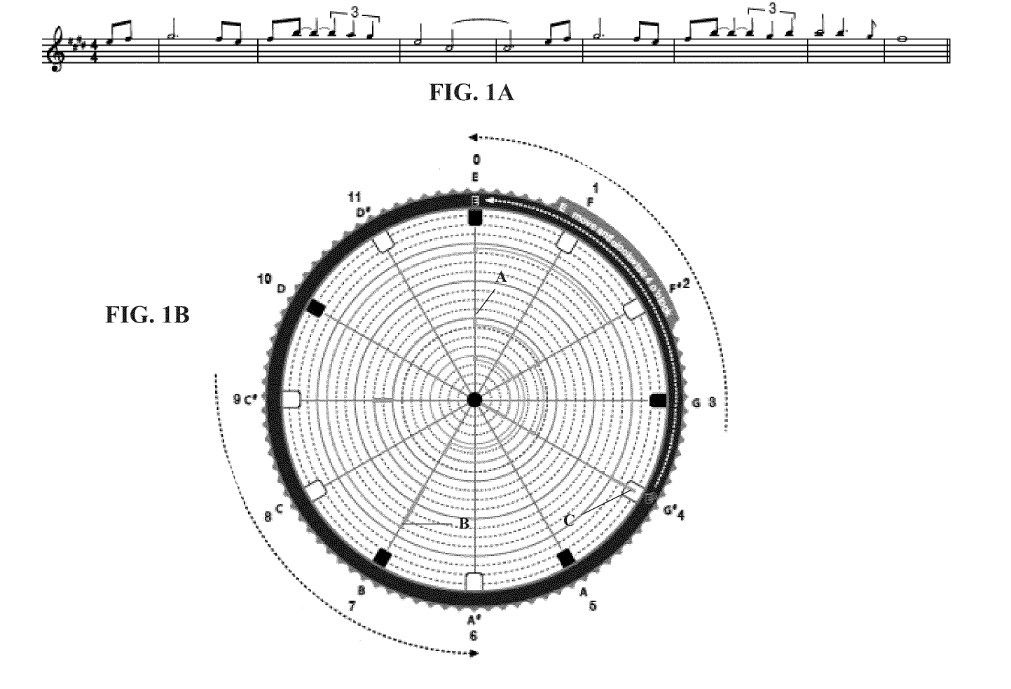

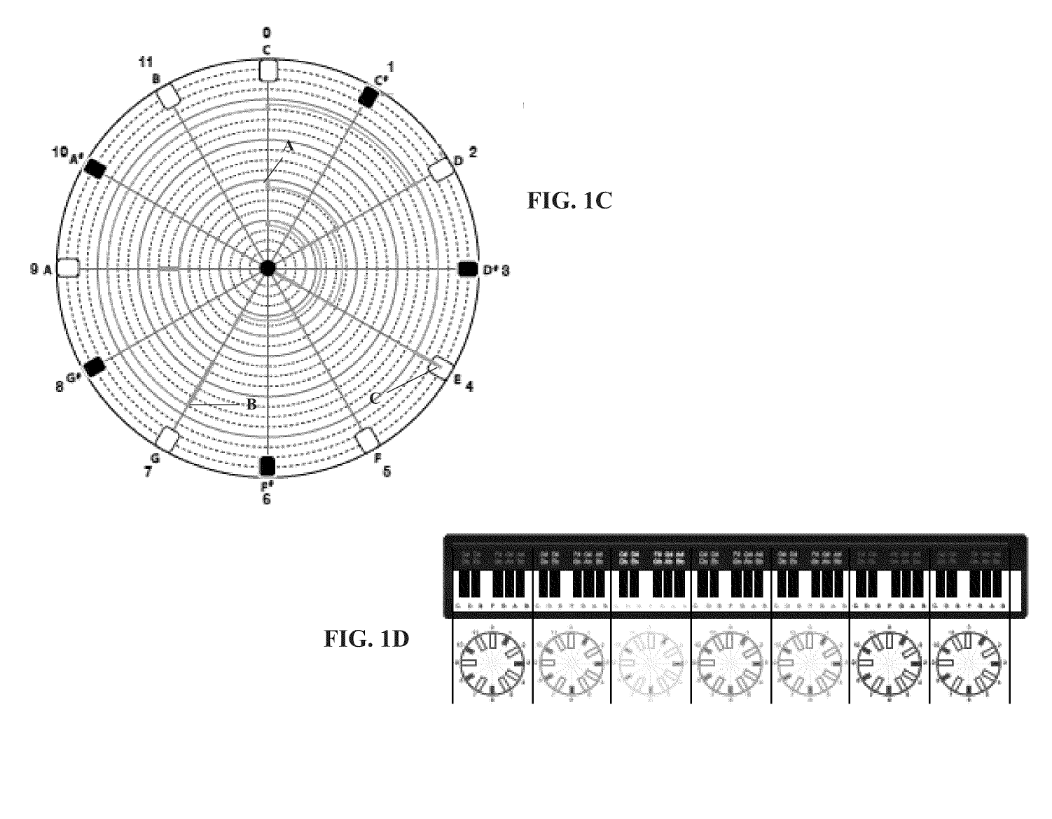

The introduction of “My heart will go on” is shown, in the key of E, in the traditional 5 line staff notation system FIG. 1A. The same musical fragment is represented, in the key of E, on the radial clock face diagram of FIG. 1B and, in the key of C, on the clock face diagram of FIG. 1C. The notes and the numbers (0-11) assigned to each of the different notes are shown around the perimeters of the radial “clock face.” The “black key” and “white key” symbols of corresponding piano notes may be shown in proximity to the note indication or number, as shown, or may be omitted. The radial diagram of FIG. 1C is oriented having the note “C” in the “0” or “12” position, indicating the music is in the key of C; the radial diagram of FIG. 1B is oriented having the note “E” in the “0” or “12” position, indicating the music is in the key of E. Changing keys is thus accomplished by means of a simple rotation of the orientation of the radial diagram.

The base-12 clock face format musical notation system is a dynamic system in which the orientation of the clock face and the orientation of the note locations with respect to one another remain constant, while notes, which are represented as colored indicators (e.g., as lines or bars) positioned at note/pitch locations (e.g. on lines radiating from the center of the clock), move dynamically from one area of the radial representation to another area as music progresses, such as from outer regions of the clock inwardly, until they reach the center of the clock face. In the embodiment in which note indicators move dynamically from an outer region of the clock face to a central location, the distance of notes from the center reflects the time until a note is played.

Thus, in the notation shown in FIG. 1B, the curved line segments from the central point of the circle to point A are represented in a first color (e.g., blue) and represent notes in one octave, while the curved line segments between point A to point B are represented in a second color (e.g., green) and represent notes in a different octave. The curved line segments between point B and point C are represented in the first color (e.g., blue) and represent notes in the first octave. The same color representations are used in the notation shown in FIG. 1C, in the same positions, as a result of the rotation of the circular, clock face representation to change the key, while the location of the notes remains constant.

The duration of notes may be indicated by the degree of elongation of the line or bar, or in other ways. The radial location of notes in any composition or key remains constant and different colors may be used to indicate different octaves, as schematically illustrated in FIG. 1D. Each of the circular representations of an octave shown below the keyboard representation of the octave in FIG. 1D is represented in a different color (shown in the referenced provisional US patent application), such as red, orange, yellow, green, light blue, dark blue and purple. Notes in different octaves are therefore distinguished from one another based on color. The key of a musical composition may be changed in this system simply by rotating the clock face and locating the desired key at the designated “key” position, such as at an upper central 0 or 12 position, as illustrated in FIGS. 1B and 1C.

The user will have the ability to control many aspects of the dynamic system, including the graphics, the tempo at which musical compositions are displayed, starting and stopping features, and the like. The musical composition may be played at the same time the musical notation is displayed to facilitate learning. Computer- and/or microprocessor-implemented methods and systems for converting musical compositions expressed in the traditional musical notation system(s) to the base-12 musical notation systems described herein will be developed.

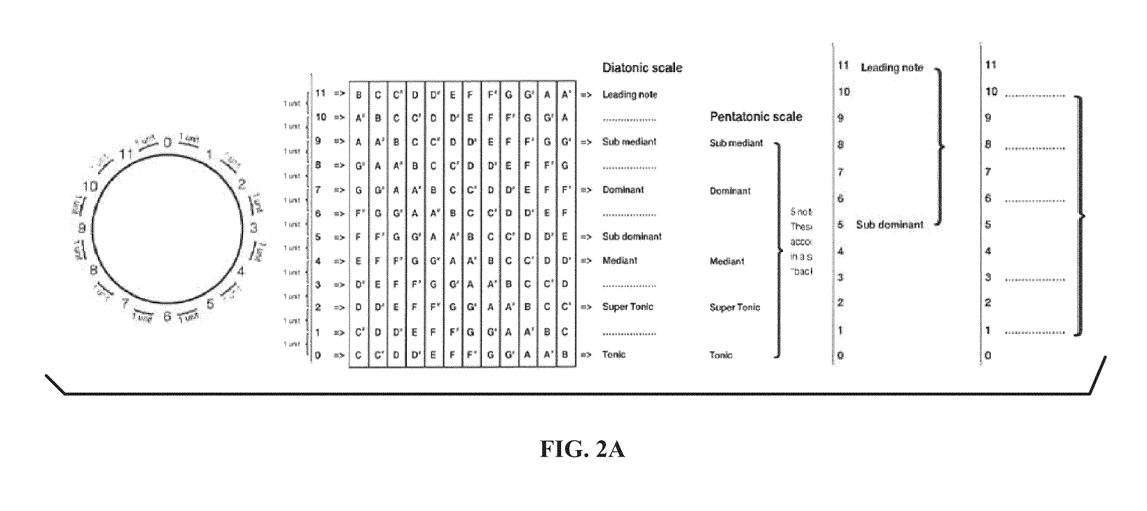

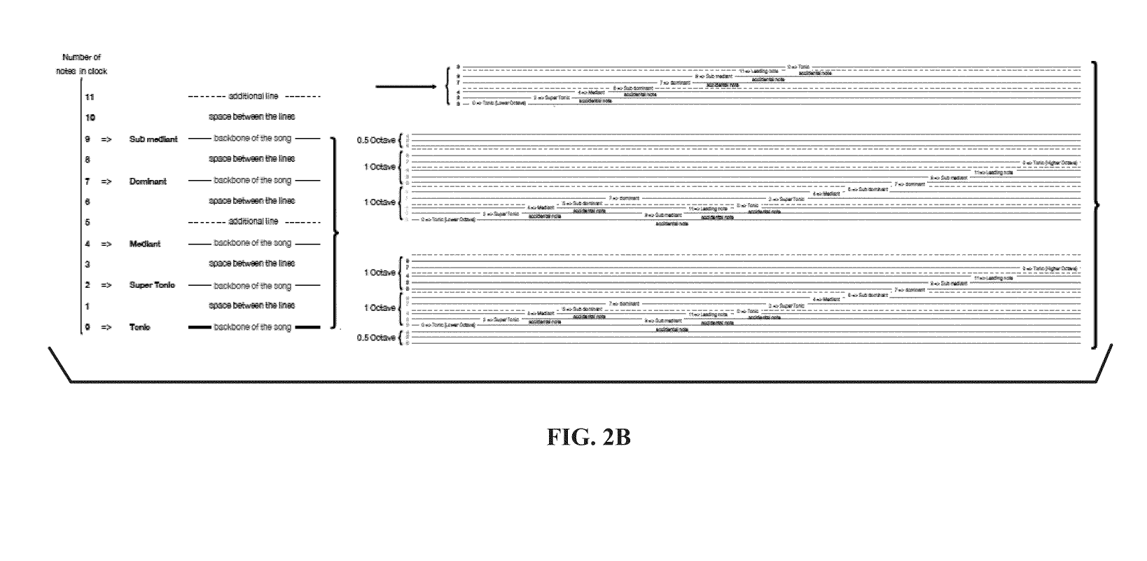

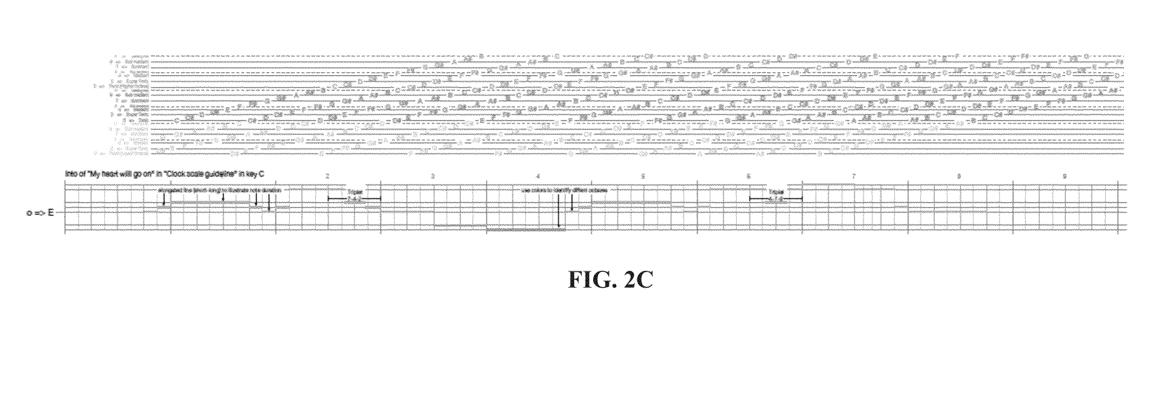

FIGS. 2A-C illustrate a static, lined notation system derived from the base-12 radial clock face notation system. The lined notation system uses the same basic methodology as the base-12 clock face system, assigning equal and distinct name-values (numbers 0 through 11) to each of the twelve possible notes and to each of 12 successive and equally spaced line positions. Each line in the dozenal-based line notation system corresponds to one of the 11 possible note pitches, and no pitches are represented in the spaces between lines or using any type of sharp or flat notation. By comparison, the traditional Western notation system displays only seven distinct notes on a staff, A through G. The five additional notes are written as A through G, but are read as a semitone above or below the written note—depending on the key signature indicated at the beginning of the piece, or on the presence of flat or sharp marks (accidentals) next to the notes.

FIG. 2A shows an adaptation of the sequence of numbers indicating notes in a radial dozenal notation (shown on the left-hand side) to a vertical axial notation, with a grid indicating the sequence of notes in a corresponding octave. To the right of the grid, elements of the diatonic and pentatonic scales are shown. The five notes of the Pentatonic (and Diatonic) scale (shown)—the Sub median, Dominant, Mediant, SuperTonic and Tonic, account for about 60-75% of notes in a song and are referred to as the “backbone of a song.” The Leading note and Sub dominant note of the Diatonic scale shown on the vertical axis in FIG. 2A are generally found in about 10%-20% of the notes used in a song. Accidental notes, represented outside the Diatonic scale and represented on the far right-hand vertical axis of FIG. 2A, are generally rarely used, and represent, perhaps, 5% of the notes used in a song.

FIG. 2B further illustrates the adaptation of the radial dozenal notation to the vertical axis notation and shows the adaptation to a lined notation system corresponding to a dozenal notation. FIG. 2C illustrates the notes labeled on a lined notation system as disclosed herein (above) and an illustration of the introduction to “My heart will go on” in the key of C in the lined notation corresponding to the dozenal-based system. FIG. 2B shows the vertical axial arrangement of the notes corresponding to numbers 0-11 on the far left-hand side, with the identification of the Sub median, Dominant, Mediant, Super Tonic and Tonic notes to the right, which represent the “backbone of the song,” as shown.

The lines corresponding to these five notes (the pentatonic scale) of the diatonic scale are used in one embodiment of the dozenal-based lined musical notation. This lined notation shows the lines corresponding to notes 0, 2, 4, 7 and 9, spaced in accordance with the spacing of the 12 line equidistant spacing. Thus, lines 0, 2 and 4 are equidistantly spaced from one another, as are lines 7 and 9 (with space corresponding to one note line between each pair), while space corresponding to two note lines is provided between the lines corresponding to notes 4 and 7 and the lines corresponding to lines 9 and 0. This notation is shown at the top of FIG. 2B. Dashed lines may be provided in spaces corresponding to more than one line, as shown, to help orient the user to recognize the spacing between lines. Lined notations representing multiple octaves may be used, as shown in the lower two lined notations shown in FIG. 2B. Each of these notations shows a 2½ octave lined notation, providing representation of notes, optionally using different colors, in the notation corresponding to different octaves.

The base-12 lined musical notation representing “My Heart Will Go On” is shown in FIG. 2C, with the notes indicated as colored bars (representing notes in different octaves) appearing on the lines, and the length of the bar indicating the note duration. The lines in the notation represent the notes of the pentatonic scale (a common scale in many musical traditions), expressed here as the “backbone of the song,” meaning the most frequently used notes in most songs. The notes of the pentatonic scale, when adapted to the base 12 lined notation system, are represented as notes (and lines) 0, 2, 4, 7 and 9, and have the (uneven) spacing corresponding to notes/lines 0, 2, 4, 7 and 9, as described above. With the clock scale line notation, the bottom line is always designated “0”, which may represent any of the twelve possible notes, and represents the key-signature note of the musical composition being expressed.

FIG. 2C graphically displays the ease with which the base-12 lined system may be used with any key signature and with multiple octaves. It also shows that dotted or dashed lines may be added, as needed, to the basic five-line system when notes 5 and 11 are represented (the notes outside the pentatonic scale most likely to be used in a song). Other notes (1, 3, 6, 8, and 10) may be displayed, when necessary, in the spaces between the lines. The width of the spaces is fixed, graphically representing the distance between the notes of the pentatonic scale, and of the expanded scale that includes the subdominant note (note 5) and the leading note (note 11). As with the clock face system, notes are shown as colored lines, with the color indicating the octave, and the line length indicating duration of the note.

The primary change when the base 12 radial system is adapted to lined notation is that the number of lines used to express a musical composition is flexible rather than fixed, and the line notation used to express compositions using different scales is different. As mentioned above, each line used in a line notation of this base 12 system, expressing any particular scale, corresponds to the line representing the note having the corresponding position in the twelve possible note/line positions. Different scales use different numbers of notes, and different notes, and the base 12 lined notation for any particular scale uses the lines corresponding to the notes of the scale. This typically results in a line notation system in which the lines are not equally spaced from one another, as they are in the traditional lined notation.

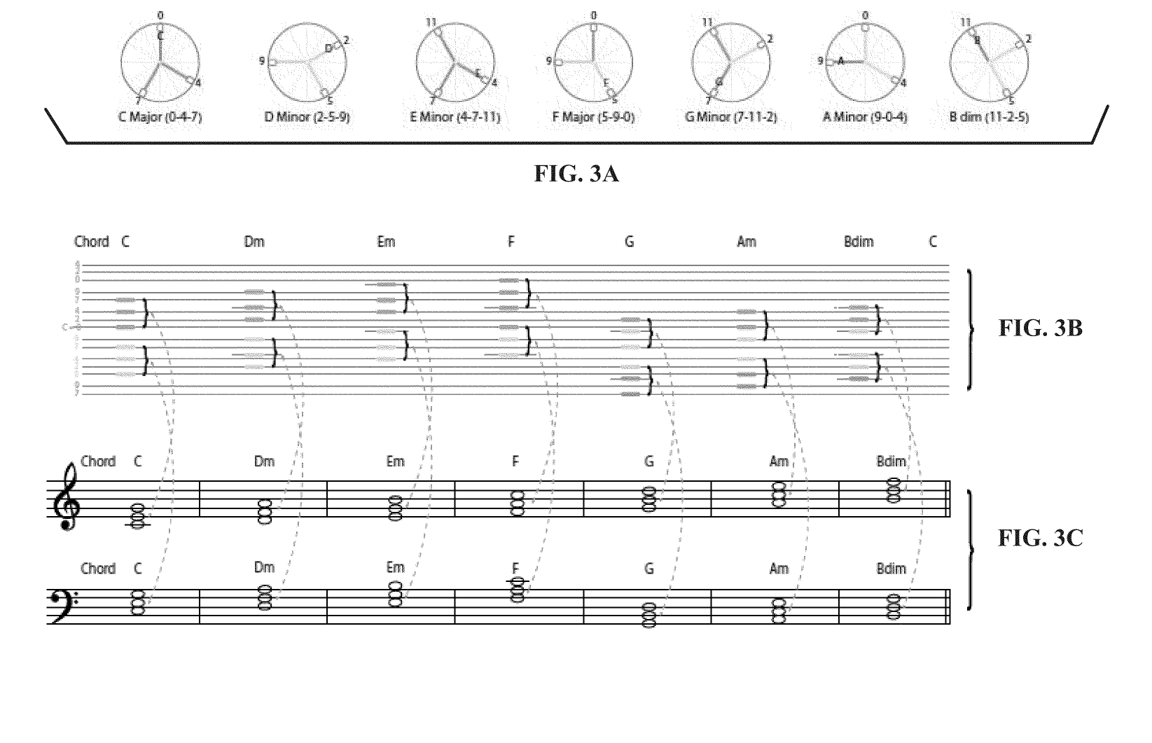

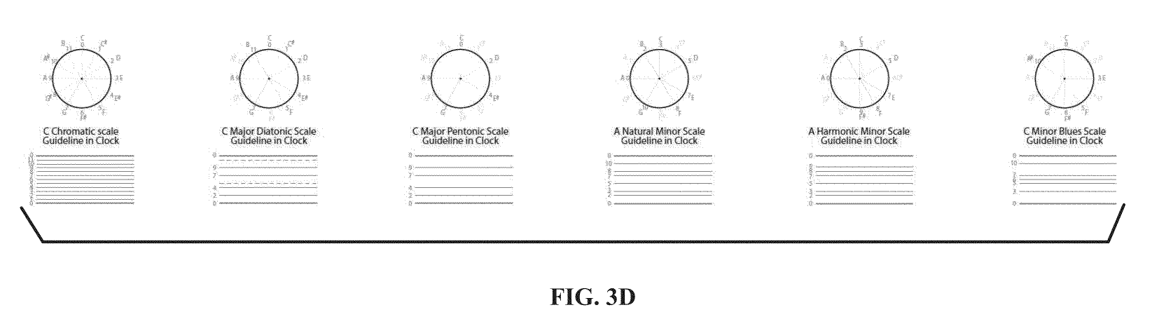

The C chromatic scale is expressed as 12 equidistantly spaced lines, each line representing a successive note of the scale (i.e., notes 1-12), with lines corresponding to the “0” defining the boundaries of the notation. (See, C Chromatic scale, left-most representation of FIG. 3D.) This lined notation, while useful in some applications, has too many lines for the eyes and brain to identify quickly and conveniently. Representing a lined notation with fewer lines by omitting some lines of the C chromatic scale, but maintaining the spacing of lines representing all 12 notes/lines of the C chromatic scale, is desirable for many applications, as described above, and such modified lined notations are shown in the other representations of FIG. 3D. Thus, the C Major Pentatonic scale, which is a subset of the Diatonic scale, is represented in the base 12 lined notation scheme as lines representing notes 0, 2, 4, 7, 9, 0 with the lines representing notes 0, 2, 4, 7, 9, 0 being spaced from one another as if all 12 lines were represented. (See, C Major Pentatonic Scale, FIG. 3D.) Additional lines, including dashed lines may be included (See, C Major Diatonic Scale, FIG. 3D) when the scale incorporates additional notes or to provide more easily perceived spacing between the lines. In some embodiments, some lines may be expressed as solid lines, while other lines may be expressed as dashed lines having the same or different properties. (See, scales and lined notations shown in FIG. 3D.) In yet other embodiments, some lines may be expressed in different colors, indicating different notes, with solid, dashed or open segments of the colored lines indicating notes played.

FIG. 3D illustrates a natural minor scale which, coincidentally, has the same pattern as the major scale but a different starting note. Thus, some keys, such as C Major and A minor, have corresponding lined notations. The natural minor scale illustrated uses lines corresponding to notes 0, 2, 3, 5, 7, 8 and 10. FIG. 3D also illustrates a harmonic minor scale using lines corresponding to notes 0, 2, 3, 5, 7, 8 and 10. This notation has three different sets or arrangements of lines: standalone (single) line (corresponding to note/line 5); line couples (corresponding to notes/lines 2 and 3); and line triplets (corresponding to notes/lines 7, 8 and 9). Representing lines in this fashion facilitates recognition of the different lines and patterns by the eyes and the brain. Finally, the far right-hand notation shown in FIG. 3D is a C Minor blues scale having 6 lines representing notes 0, 3, 5, 6, 7 and 10, providing a unique line pattern. These various line notations are illustrative of the variety of lined notations that may be used, and those having skill in the art will appreciate that many more variations of the lined notations are possible and would be useful for representing different scales used in different musical compositions. The common feature of the lined notations is that the spacing of the 12 lines representing the 12 notes is constant, with different numbers of lines being “shown” and omitted, resulting in different patterns of lined notations, and with different representations of lines being available.

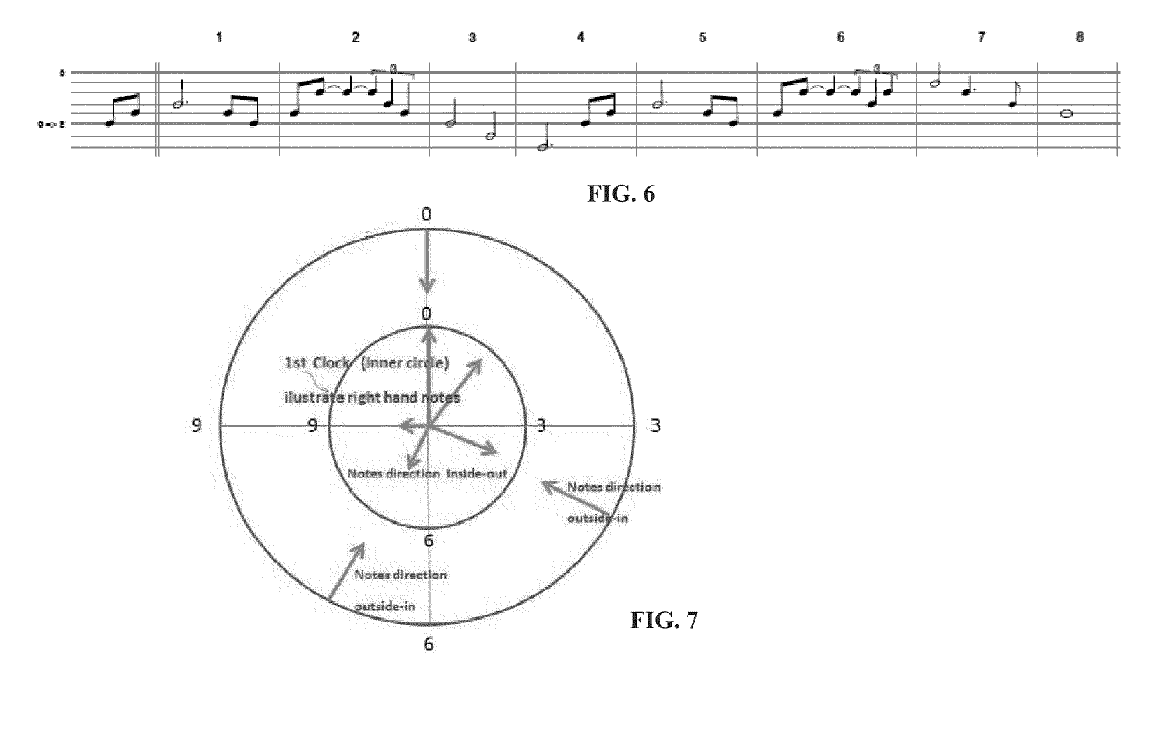

In alternative embodiments of the base-12 line notation system of the present invention, traditional musical note representations such as those used in the traditional five-line staff musical notations (e.g., whole notes, half notes, quarter notes, etc.), may be used with the novel base-12 line notation system. In this type of hybrid system, note pitch is expressed as the location of the note in the lined system (e.g., line locations 1-12), pitch octave may be expressed as color, and note duration is expressed by the note type and representation (e.g. whole note, half note, quarter note, etc.). FIG. 6 shows the introduction of “My Heart Will Go On” expressed in a hybrid base-12 lined notation system in the key of E. In this notation, expressed using the C Major pentatonic scale (using lines representing notes 0, 2, 4, 7 and 9), the lines are not all equidistantly spaced from neighboring lines (e.g., there is a single line spacing between notes 0 and 2, 2 and 4 and 7 and 9, and a double line spacing between notes 4 and 7), and traditional notes are positioned on the lines to indicate pitch. Note duration is indicated by the traditional value of the note (e.g., whole note, half note, etc.).

There are many ways to illustrate melody notes and chords in the dynamic clock mode musical system. FIG. 3A illustrates exemplary musical representations of several different chords in the base-12 clock face notation, FIG. 3B illustrates exemplary musical representations of the clock scale line notation, and FIG. 3C illustrates the conventional 5 staff musical notation. As shown in FIG. 3A, the C Major chord is represented by line segments extending from the center of the radial representation to note positions 0, 4 and 7; The D Minor chord is represented by line segments extending from the center of the radial representation to note positions 2, 5 and 9; the E Minor chord is represented by line segments extending from the center of the radial representation to note positions 4m 7 and 11; the F Major chord is represented by line segments extending from the center of the radial representation to note positions 5, 9 and 0; the G Minor chord is represented by line segments extending from the center of the radial representation to note positions 7, 11 and 2; The A Minor chord is represented by line segments extending from the center of the radial representation to note positions 9, 0 and 4; and the B dim chord is represented by line segments extending from the center of the radial representation to note positions 11, 2 and 5. Notes of different octaves are represented in different colors.

FIG. 3B shows the same chords as shown in FIG. 3A on the dozenal-based line notation (using lines 0, 2, 4, 7, 9, 0), shown in two different octaves. Different octaves are indicated by the position of the line segments in the (double octave) notation shown, and differently colored line segments may additionally indicate notes in different octaves. FIG. 3C shows the corresponding chords expressed in the traditional 5-staff musical notation.

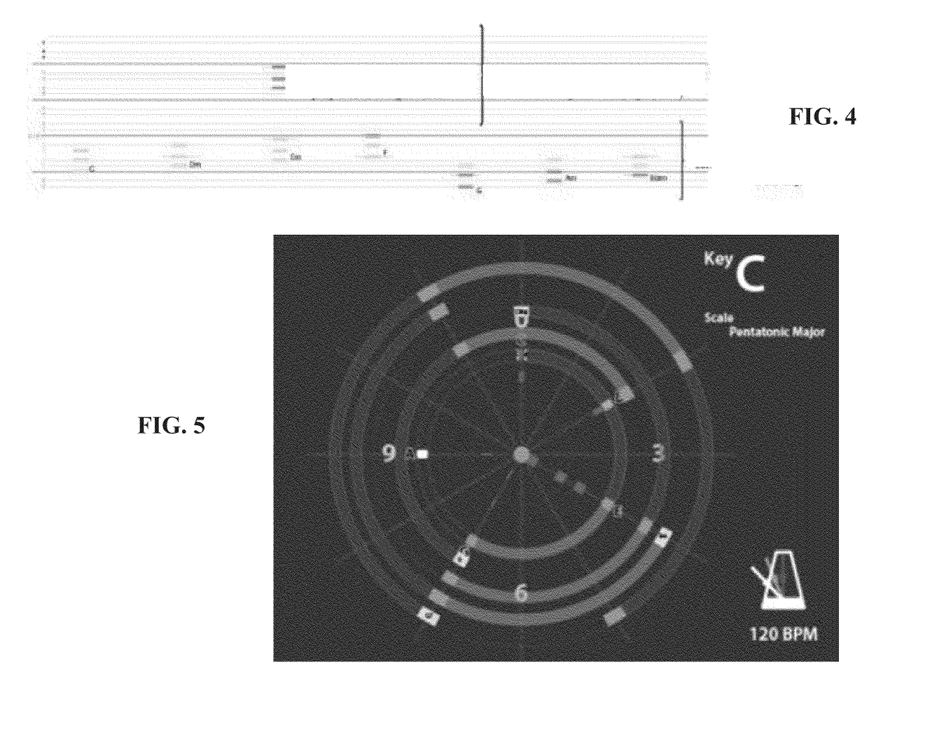

In another exemplary embodiment shown in FIG. 4, a multiple octave lined notation is shown, demonstrating how chords and melody notes may be shown simultaneously using the base-12 line notation. The lower range chords normally played using the left hand are shown in the lower notation, while some higher range chords, normally played by the right hand, are shown in the notation(s) above the lower range notation. The melody notes are typically (but not always) shown in the upper range notation. The dozanel-based lined notation may implement as many notation “sets,” shown above and below one another, as necessary to express notes in any given musical composition.

In yet another exemplary representation shown in FIG. 5, melody notes are shown in combination with chords in the base-12 clock face notation. In the base-12 radial notation shown in FIG. 5, melody notes appear in the inner regions of the radial representation and chords appear in outer or peripheral regions of the radial representation. The melody notes represented in the inner regions are in the color representing one octave; the chords appearing in the outer regions of the radial representation are also presented in different colors representing different notes of different octaves.

In yet another exemplary embodiment, multiple radial elements may be combined to illustrate music played by different hands, or to illustrate both melody notes and chords. In the diagram shown in FIG. 7, for example, the inner circle, called the “1^{st} Clock,” is used to illustrate the right hand notes, in this case, melody notes or chords. In the depiction shown in FIG. 7, the notes in the inner circle are dynamically represented moving from a center location outwardly and are played when they're located in a peripheral location near the border of the inner circle with the outer circle. The outer circle, or outer annular ring shown in FIG. 7, is used to express notes or chords played by the left hand. These notes may be dynamically represented moving from the periphery toward an inner edge of the outer ring. In this base-12 radial musical notation, all notes are played (both left hand and right hand) as or when the approach or touch the ring at the intersection of the inner and outer portions of the system.

Display devices for displaying musical compositions, and musical instruments or accessories incorporating display devices are contemplated. Libraries of musical compositions may be made available to and selectable by a user, for example, through an interactive user interface device. The interactive user interface device may be a computer terminal and display (e.g., a personal computer or kiosk or the like), a personal digital assistant (PDA), a digital device such as a telephone, smart phone, tablet, camera, a musical instrument having a display associated with it, or the like. The interactive user interface device may additionally be provided as a digital watch or wall-type clock having a generally circular face. Digital devices having a generally round configuration are especially suitable for displaying the base 12 musical notation in the radial format, as described herein.

The interactive user interface device typically communicates with a host system, or a content engine, via a communications network such as a local area network (LAN), a wide area network (WAN), a wired or wireless network, an intranet, an internet, a cell network, a satellite network, or the like. The content engine(s) is generally maintained by someone other than the user, and is configured to provide users with user-selectable content. Computer- and/or microprocessor-implemented methods and systems for converting musical compositions expressed in the traditional musical notation system to one or more of the musical notation systems described herein are also contemplated.

It will be appreciated that the methods and systems of the present invention may be embodied in a variety of different forms, and that the specific embodiments shown in the figures and described herein are presented with the understanding that the present disclosure is considered exemplary of the principles of the invention, and is not intended to limit the invention to the illustrations and description provided herein.

1. A musical notation system utilizing a base-12 system, graphically represented in a clock-face format.

2. The musical notation system of claim 1, Wherein successive notes and chords are expressed as colored indicators located at radial locations corresponding to individual notes.

3. The musical notation system of claim 2, wherein colored note indicators move dynamically from outer perimeter regions of the clock-face toward the center as a musical composition progresses.

4. The musical notation system of claim 2, wherein colored note indicators move dynamically from inner regions of the clock-face toward outer perimeter regions as a musical composition progresses.

5. The musical notation system of claim 1, wherein colored note indicators representing both melody notes and chords are expressed in a clock-face format.

6. The musical notation system of claim 1, wherein one area of the clock-face format expresses right hand notes and another area of the clock-face format expresses left-hand notes.

7. The musical notation system of claim 6, wherein one area of the clock-face format is an inner circular area and another area of the clock-face format is an annular area that is peripheral to the inner circular area.

8. A musical notation system utilizing a base-12 lined notation system, wherein equal and distinct name-values (numbers 0 through 11) are assigned to each of the twelve possible notes and line positions, and the number of lines used in the notation system is flexible based on the seale(s) in which a composition may be expressed.

9. The musical notatation system of claim 8, wherein the tom line of the lined notation system represents the key signature of the musical composition.

10. The musical notation system of claim 8, wherein the number of lines shown and the spacing between the lines used to express a musical composition corresponds to the scale in which the composition is expressed.

11. The musical notation system of claim 8, in which the notes of the pentatonic scale (notes 0, 2, 4, 7 and 9) are represented as a 5-lined notation and additional dotted lines represent notes outside the pentatonic scale.

12. The musical notation system of claim 8, in which notes are expressed as lines or bars and the duration of the note corresponds to the length of the line or bar.

13. The musical notation system of claim 8, in which notes are expressed as traditional notes (e.g., whole notes, half notes etc.) and the duration of the note corresponds to the traditional notation.

14. (canceled)
